(19) United States
(12) Patent Application Publication
(10) Pub. No.: US 2026/0183904 A1
(43) Pub. Date: Jul. 2, 2026

(54) Clamping Tool

(71) Applicant: HANGZHOU GREAT STAR INDUSTRIAL CO., LTD., Hangzhou, Zhengjiang (CN)

(72) Inventors: Feng LI, Hangzhou, Zhengjiang (CN); Wei WANG, Hangzhou, Zhengjiang (CN)

(73) Assignee: HANGZHOU GREAT STAR INDUSTRIAL CO., LTD., Hangzhou, Zhengjiang (CN)

(21) Appl. No.: 18/863,831

(22) PCT Filed: May 11, 2022
(86) PCT No.: PCT/CN2022/092239

§ 371 Date: Nov. 7, 2024

(51) Int. Cl. B25B 7/10; B25B 7/02

(52) U.S. Cl. CPC B25B 7/10; B25B 7/02

(57) ABSTRACT

Disclosed is a clamping tool, including a first plier body, a second plier body, and a pivot connection locking mechanism, wherein the first plier body includes a first handle body and a first plier head; the second plier body includes a second handle body and a second plier head, the second plier body being hinged with the first plier body; the pivot connection locking mechanism is movably arranged at a position where the first plier body is hinged with the second plier body; the pivot connection locking mechanism has an unlocked state and a locked state; when in the locked state, the first plier head is pivotally connected with the second plier head; and when in the unlocked state, the first plier head and the second plier head can move toward or away from each other.

### CROSS-REFERENCE TO RELATED APPLICATION(S)

The present disclosure is a national stage application of International Patent Application No. PCT/CN2022/092239, which is filed on May 11, 2022.

### TECHNICAL FIELD

The present disclosure relates to the technical field of hardware tools, and in particular to a clamping tool.

### BACKGROUND

Pliers are a commonly used tool in maintenance, and may be specifically used to clamp various parts or disassemble parts.

In the related art, the opening of jaws is achieved through an articulated shaft, but since the position of the articulated shaft is fixed, the opening size of the jaws is also fixed, which results in the pliers being adaptable only to parts of a certain size range, so that the universality of the pliers is poor.

### SUMMARY

The main objective of the present disclosure is to provide a clamping tool to solve the problem in the related art of poor universality of pliers.

In order to achieve the above objective, the present disclosure provides a clamping tool, including: a first plier body, including a first handle body and a first plier head arranged at an end of the first handle body; a second plier body including a second handle body and a second plier head arranged at an end of the second handle body, the second plier body being hinged with the first plier body; a pivot connection locking mechanism movably arranged at a position where the first plier body is hinged with the second plier body. The pivot connection locking mechanism has an unlocked state and a locked state. When in the locked state, the first plier head is pivotally connected with the second plier head. When in the unlocked state, the first plier head and the second plier head can move toward or away from each other.

Further, the first plier body and the second plier body are arranged crosswise.

Further, when the pivot connection locking mechanism rotates or moves, the pivot connection locking mechanism switches between the locked state and the unlocked state. When the pivot connection locking mechanism is in the unlocked state, the pivot connection locking mechanism can move, so that the first plier head and the second plier head move toward or away from each other.

Further, when the pivot connection locking mechanism is in the unlocked state, the first plier head moves toward the second plier head, or the second plier head moves toward the first plier head.

Further, the second handle body includes an accommodating groove. At least part of a structure of the first handle body can be inserted into the accommodating groove, the first handle body is provided with a first sliding groove, and the pivot connection locking mechanism is movably arranged in the first sliding groove.

Further, the pivot connection locking mechanism includes an articulated shaft and a locking piece. The articulated shaft penetrates through the second handle body and the locking piece.

Further, a snap-fit structure is arranged between the locking piece and an inner wall of the first sliding groove, and the snap-fit structure includes a first convex tooth and a first rack. One of the first convex tooth and the first rack is arranged on the locking piece, the other of the first convex tooth and the first rack is arranged in the first sliding groove, and the first convex tooth and the first rack are snap-fitted.

Further, the first convex tooth is arranged on the locking piece, the first rack is arranged on an inner wall, close to the first plier head, of the first sliding groove, the first convex tooth protrudes toward a side facing the first plier head, or the first rack is arranged on an inner wall, away from the first plier head, of the first sliding groove, and the first convex tooth protrudes toward a side away from the first plier head.

Further, the clamping tool further includes an abutting piece. The abutting piece is fixed on one of the first handle body and the second handle body and is in abutting fit with the other of the first handle body and the second handle body.

Further, the abutting piece is arranged on the second handle body and is in abutting fit with the first handle body.

Further, the abutting piece includes an elastic sheet.

Further, the abutting piece includes an elastic arm. The elastic arm has a locked position and an unlocked position. When the elastic arm is in the locked position, the elastic arm is located inside the second handle body. When the elastic arm is in the unlocked position, the elastic arm is in supporting fit with the first handle body and drives the first handle body to move in a direction away from the second handle body.

Further, the locking piece includes a first locking block and a protrusion connected with the first locking block. The first convex tooth is arranged on the first locking block, the first locking block is movably arranged in the first sliding groove, the first handle body is further provided with a second sliding groove, the protrusion is movably arranged in the second sliding groove, an inner side wall of the accommodating groove is convexly provided with a stop column located in the second sliding groove, and the stop column cooperates with the protrusion.

Further, the first sliding groove is adjacent to and communicates with the second sliding groove.

Further, a side, facing the second sliding groove, of the first locking block is provided with a first mounting hole, and the pivot connection locking mechanism further includes a first elastic piece, which is inserted into the first mounting hole and is in abutting fit with the inner wall of the first sliding groove.

Further, the articulated shaft can move in an axial direction of the articulated shaft, a side wall of the articulated shaft is provided with a spiral groove, the locking piece is provided with a second mounting hole, the locking piece is provided with a driving block extending into the second mounting hole, and the driving block is inserted into the spiral groove.

Further, a first end of the articulated shaft is located on a first side of the second handle body and is provided with a first pressing part, a second end of the articulated shaft is located on a second side of the second handle body and is provided with a threaded part, and the pivot connection locking mechanism further includes a second elastic piece and a fastener, the second elastic piece being arranged between the first pressing part and the first side of the second handle body, and the fastener being fixedly connected with the threaded part.

Further, the first side of the second handle body is provided with a first recess, the second side of the second handle body is provided with a second recess, the second elastic piece is arranged in the first recess, and the fastener is arranged in the second recess.

Further, the locking piece includes a second locking block and a guide block. The guide block is arranged on a first side wall of the second locking block, at least one side of the guide block is provided with a second convex tooth, a side wall of the first sliding groove is provided with a guide groove and a second rack, the guide block is in guide fit with the guide groove, and the second convex tooth and the second rack are snap-fitted.

Further, the locking piece includes a third mounting hole. The third mounting hole is arranged at a center of the second locking block and penetrates through the guide block, the articulated shaft penetrates through the third mounting hole, a first end of the articulated shaft is provided with a second pressing part, and the pivot connection locking mechanism further includes a third elastic piece, which is arranged between the second pressing part and the second handle body.

Further, a side, facing the second plier head, of the first plier head is provided with a first clamping surface, and a side, facing the first plier head, of the second plier head is provided with a second clamping surface. The first clamping surface includes a first surface part, a second surface part, and a third surface part, a first obtuse angle being provided between the first surface part and the second surface part, and a second obtuse angle being provided between the second surface part and the third surface part. The second clamping surface includes a fourth surface part, a fifth surface part, and a sixth surface part, a third obtuse angle being provided between the fourth surface part and the fifth surface part, and a fourth obtuse angle being provided between the fifth surface part and the sixth surface part. The first obtuse angle is greater than the second obtuse angle, and the third obtuse angle is greater than the fourth obtuse angle.

Further, the first surface part is provided with a first tooth groove, the second surface part is provided with a second tooth groove, the third surface part is a smooth surface, the fourth surface part is provided with a third tooth groove, the fifth surface part is a smooth surface, and the sixth surface part is provided with a fourth tooth groove. A tooth width of the first tooth groove is smaller than a tooth width of the second tooth groove, a tooth width of the third tooth groove is smaller than a tooth width of the fourth tooth groove, the tooth width of the first tooth groove is equal to the tooth width of the third tooth groove, and the tooth width of the second tooth groove is equal to the tooth width of the fourth tooth groove.

By applying the technical solution of the present disclosure, the first plier body is hinged with the second plier body, the first plier body includes the first handle body and the first plier head arranged at the end of the first handle body, the second plier body includes the second handle body and the second plier head arranged at the end of the second handle body, and an opening angle between the first plier body and the second plier body can be increased or decreased. The pivot connection locking mechanism is arranged at the position where the first plier body is hinged with the second plier body, and the pivot connection locking mechanism has the locked state and the unlocked state. When in the unlocked state, the first plier head and the second plier head can move toward or away from each other. Through the above arrangement, the pivot connection locking mechanism can move, so that an articulated point of the first plier body and the second plier body can be changed, and then an opening between the first plier head and the second plier head can be enlarged, so that the clamping tool can clamp parts of different sizes. Therefore, the technical solution of the present disclosure effectively solves the problem in the related art of poor universality of pliers.

### BRIEF DESCRIPTION OF THE DRAWINGS

The accompanying drawings of the specification, which constitute a part of the present disclosure, are intended to provide a further understanding of the present disclosure, and the exemplary embodiments of the present disclosure and the description thereof are intended to explain the present disclosure and do not constitute an undue limitation on the present disclosure. In the accompanying drawings:

FIG. 1 shows a three-dimensional schematic diagram of Embodiment 1 of a clamping tool according to the present disclosure.

FIG. 2 shows a schematic cross-sectional view of the clamping tool of FIG. 1.

FIG. 3 shows a partial enlarged diagram of a place A of the clamping tool of FIG. 2.

FIG. 4 shows a schematic exploded view of the clamping tool of FIG. 1.

FIG. 5 shows a schematic side view of a second plier body of the clamping tool of FIG. 4.

FIG. 6 shows a perspective schematic diagram of the clamping tool of FIG. 1.

FIG. 7 shows a schematic structural diagram of rotation of a second plier body of the clamping tool of FIG. 1.

FIG. 8 shows a schematic structural diagram of separation of a first convex tooth and a first rack of the clamping tool of FIG. 1.

FIG. 9 shows a schematic structural diagram of engagement of a first convex tooth and a first rack of the clamping tool of FIG. 1.

FIG. 10 shows a schematic structural diagram of the clamping tool of FIG. 1 when clamping a first part.

FIG. 11 shows a schematic structural diagram of the clamping tool of FIG. 1 when clamping a second part.

FIG. 12 shows a schematic structural diagram of the clamping tool of FIG. 1 when clamping a third part.

FIG. 13 shows a partial vertical schematic cross-sectional diagram of Embodiment 2 of a clamping tool according to the present disclosure.

FIG. 14 shows a transverse schematic cross-sectional view of the clamping tool of FIG. 13.

FIG. 15 shows a schematic diagram of a three-dimensional structure of an articulated shaft of the clamping tool of FIG. 13.

FIG. 16 shows a partial vertical schematic cross-sectional diagram of Embodiment 3 of a clamping tool according to the present disclosure.

FIG. 17 shows a schematic diagram of a three-dimensional structure of a second locking block of the clamping tool of FIG. 16.

FIG. 18 shows a schematic bottom view of a second rack of the clamping tool of FIG. 16.

Herein, the above accompanying drawings include the following reference signs.

10. First plier body; 11. First handle body; 111. First sliding groove; 1111. Guide groove; 112. Second sliding groove; 12. First plier head; 121. First clamping surface; 1211. First surface part; 1212. Second surface part; 1213. Third surface part; 20. Second plier body; 21. Second handle body; 211. Accommodating groove; 212. Stop column; 213. First recess; 214. Second recess; 22. Second plier head; 221. Second clamping surface; 2211. Fourth surface part; 2212. Fifth surface part; 2213. Sixth surface part; 30. Pivot connection locking mechanism; 31. Articulated shaft; 311. Spiral groove; 312. First pressing part; 313. Threaded part; 314. Second pressing part; 32. Locking piece; 321. First locking block; 3211. First mounting hole; 322. Protrusion; 323. Second mounting hole; 324. Driving block; 325. Second locking block; 326. Guide block; 327. Third mounting hole; 33. First elastic piece; 341. Second elastic piece; 342. Fastener; 35. Third elastic piece; 40. Snap-fit structure; 41. First convex tooth; 42. First rack; 50. Abutting piece; 61. Second convex tooth; 62. Second rack.

### DETAILED DESCRIPTION OF THE EMBODIMENTS

The technical solutions in the embodiments of the present disclosure will be clearly and completely described in conjunction with the accompanying drawings in the embodiments of the present disclosure. It is apparent that the described embodiments are only a part of the embodiments of the present disclosure, and not all of them. The following description of at least one exemplary embodiment is only illustrative, and in no way serves as any limitation on the present disclosure or application or use thereof. All other embodiments obtained by those of ordinary skill in the art based on the embodiments of the present disclosure without creative efforts are within the scope of protection of the present disclosure.

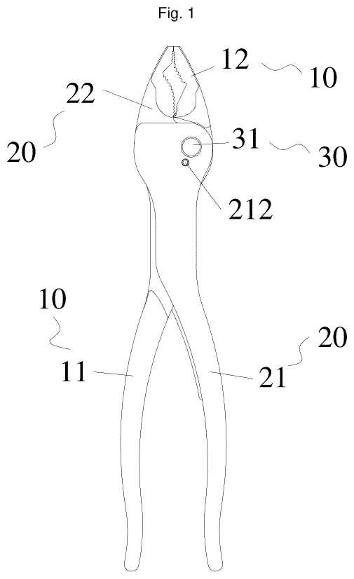

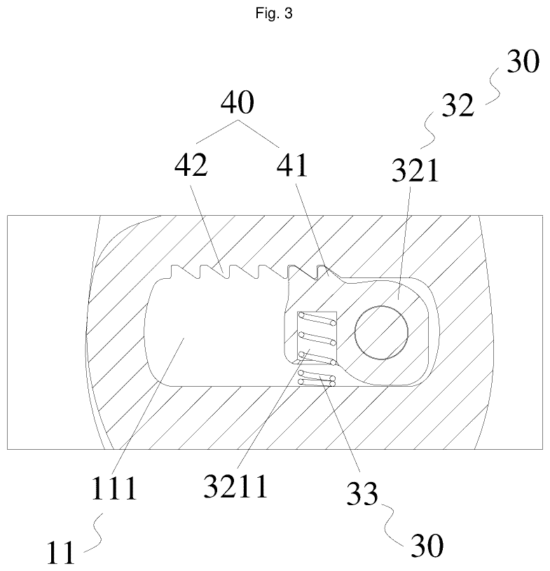

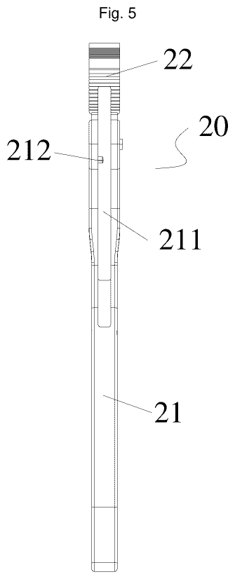

As shown in FIG. 1 to FIG. 5, in Embodiment 1, a clamping tool includes: a first plier body 10, a second plier body 20, and a pivot connection locking mechanism 30. The first plier body 10 includes a first handle body 11 and a first plier head 12 arranged at an end of the first handle body 11. The second plier body 20 includes a second handle body 21 and a second plier head 22 arranged at an end of the second handle body 21, the second plier body 20 being hinged with the first plier body 10. The pivot connection locking mechanism 30 is movably arranged at a position where the first plier body 10 is hinged with the second plier body 20. The pivot connection locking mechanism 30 has an unlocked state and a locked state. When in the locked state, the first plier head 12 is pivotally connected with the second plier head 22. When in the unlocked state, the first plier head 12 and the second plier head 22 can move toward or away from each other.

By applying the technical solution of the embodiment, the first plier body 10 is hinged with the second plier body 20, the first plier body 10 includes the first handle body 11 and the first plier head 12 arranged at the end of the first handle body 11, the second plier body 20 includes the second handle body 21 and the second plier head 22 arranged at the end of the second handle body 21, and an opening angle between the first plier body 10 and the second plier body 20 can be increased or decreased. The pivot connection locking mechanism 30 is arranged at the position where the first plier body 10 is hinged with the second plier body 20, and the pivot connection locking mechanism 30 has the locked state and the unlocked state. When in the unlocked state, the first plier head 12 and the second plier head 22 can move toward or away from each other. Through the above arrangement, the pivot connection locking mechanism 30 can move, so that an articulated point of the first plier body 10 and the second plier body 20 can be changed, and then an opening between the first plier head 12 and the second plier head 22 can be enlarged, so that the clamping tool can clamp parts of different sizes. Therefore, the technical solution of the embodiment effectively solves the problem in the related art of poor universality of pliers.

The first plier body 10 and the second plier body 20 are arranged crosswise. Through the above arrangement, the relative movement of the first plier body 10 and the second plier body 20 is more stable. Specifically, in the embodiment, part of a structure of the first plier body extends into the second plier body.

In an embodiment not shown in the figures, part of the structures of the first plier body and the second plier body are attached, and the pivot connection locking mechanism is located at the position where the first plier body is attached to the second plier body. Specifically, the first plier body and the second plier body are both sheet-shaped. In this way, the above functions can also be achieved, that is, a distance between a first plier head and a second plier head can be increased or decreased, so that the cooperative use with parts of different sizes can be achieved.

When the pivot connection locking mechanism 30 rotates or moves, the pivot connection locking mechanism 30 switches between the locked state and the unlocked state. When the pivot connection locking mechanism 30 is in the unlocked state, the pivot connection locking mechanism 30 can move, so that the first plier head 12 and the second plier head 22 move toward or away from each other. Through the above arrangement, the unlocking and locking of the pivot connection locking mechanism 30 can be effectively achieved, so that the first plier body 10 and the second plier body 20 can move toward or away from each other.

When the pivot connection locking mechanism 30 is in the unlocked state, the first plier head 12 moves toward the second plier head 22. Specifically, the technical solution of the embodiment can achieve the independent movement of the first plier head 12. Of course, the second plier head 22 moves toward the first plier head 12. That is, the second plier body can also move independently.

As shown in FIG. 1 to FIG. 5, in Embodiment 1, the second handle body 21 includes an accommodating groove 211. At least part of a structure of the first handle body 11 can be inserted into the accommodating groove 211, the first handle body 11 is provided with a first sliding groove 111, and the pivot connection locking mechanism 30 is movably arranged in the first sliding groove 111. The accommodating groove 211 is arranged at a side of the second handle body 21 and penetrates through the second handle body 21, so that the first handle 11 can penetrate out of the accommodating groove 211, and the first plier body 10 can be hinged with the second plier body 20. The first sliding groove 111 is arranged on the first handle body 11, the first sliding groove 111 penetrates through the first handle body 11, the pivot connection locking mechanism 30 is arranged in the first sliding groove 111, the first sliding groove 111 is located in the accommodating groove 211, and the pivot connection locking mechanism 30 can move in the first sliding groove 111, so that the articulated point of the first plier body 10 and the second plier body 20 moves in the first sliding groove 111. In this way, the opening between the first plier head 12 and the second plier head 22 can be enlarged.

As shown in FIG. 1 to FIG. 5, in Embodiment 1, the pivot connection locking mechanism 30 includes an articulated shaft 31 and a locking piece 32. The articulated shaft 31 penetrates through the second handle body 21 and the locking piece 32. The locking piece 32 can lock its own position, that is, when the articulated point does not need to continue moving, the locking piece 32 can lock the position of the articulated point, so that the first plier body 10 and the second plier body 20 move toward each other more stably. The midpoint of the articulated shaft 31 is the articulated point, and the articulated shaft 31 can connect the locking piece 32 and the second handle body 21 together. Since the locking piece 32 is located between the accommodating groove 211 of the second handle body 21 and the first sliding groove 111, the first handle body 11 and the second handle body 21 can be hinged together, and the rotation of the first plier body 10 and the second plier body 20 can be achieved.

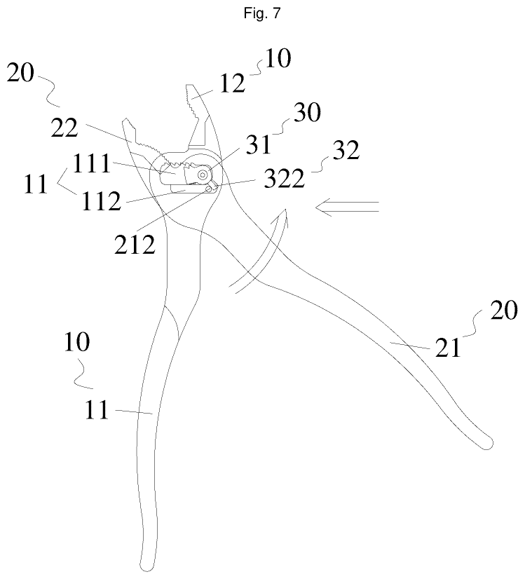

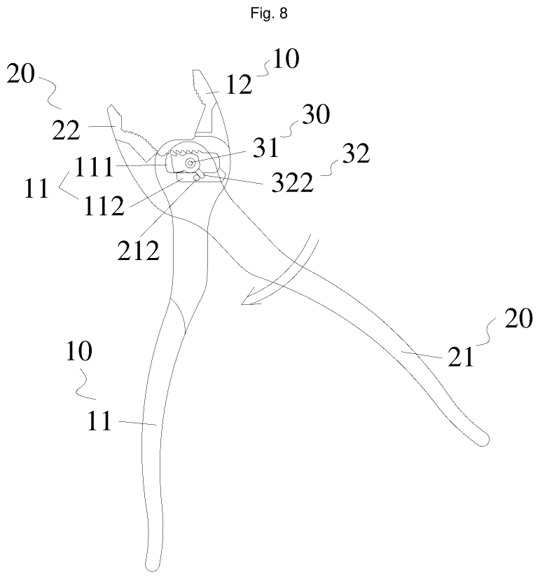

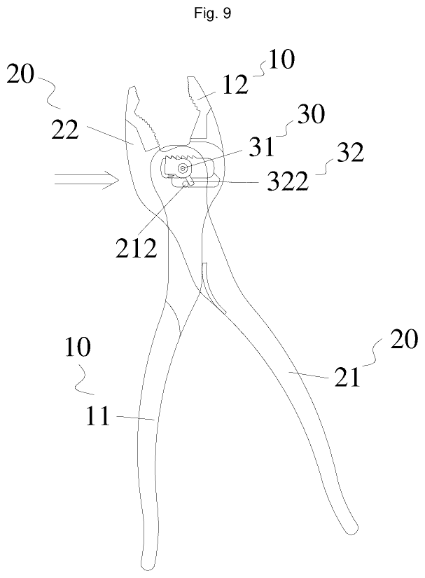

As shown in FIG. 1 to FIG. 9, in Embodiment 1, a snap-fit structure 40 is arranged between the locking piece 32 and an inner wall of the first sliding groove 111, and the snap-fit structure 40 includes a first convex tooth 41 and a first rack 42. One of the first convex tooth 41 and the first rack 42 is arranged on the locking piece 32, the other of the first convex tooth 41 and the first rack 42 is arranged in the first sliding groove 111, and the first convex tooth 41 and the first rack 42 are snap-fitted. The snap-fit structure can lock the locking piece and the first plier body, specifically, the snap-fit structure includes the first convex tooth and the first rack, and the first convex tooth and the first rack can be engaged with each other, and when the first rack is engaged with the first convex tooth, the locking between the locking piece and the first handle body can be achieved. In the embodiment, the first convex tooth is arranged on the locking piece, and the first rack is arranged on the first sliding groove.

As shown in FIG. 1 to FIG. 9, in Embodiment 1, the first convex tooth 41 is arranged on the locking piece 32, the first rack 42 is arranged on an inner wall, close to the first plier head 12, of the first sliding groove 111, the first convex tooth 41 protrudes toward a side facing the first plier head 12. The first rack 42 is arranged on the inner wall of the first sliding groove 111, so that the length of the first rack 42 can be large enough, that is, the locked positions of the first convex tooth 41 and the first rack 42 can be more. The first rack 42 is arranged on the inner wall, close to the first plier head 12, of the first sliding groove 111, so that the locking of the locking piece 32 can be simpler.

Of course, in the embodiment not shown in the figures, the first rack is arranged on an inner wall, away from the first plier head, of the first sliding groove, and the first convex tooth protrudes toward a side away from the first plier head.

It is to be noted that the above first sliding groove 111 includes a bottom wall, a top wall, and two connecting walls connected between the top wall and the bottom wall. The top wall is located between the bottom wall and the first plier head 12, and the inner wall, close to the first plier head 12, of the above first sliding groove 111 refers to the top wall.

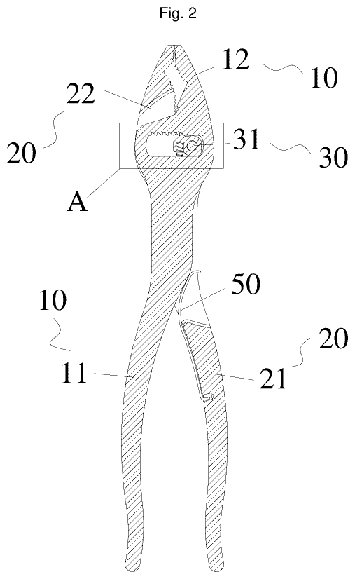

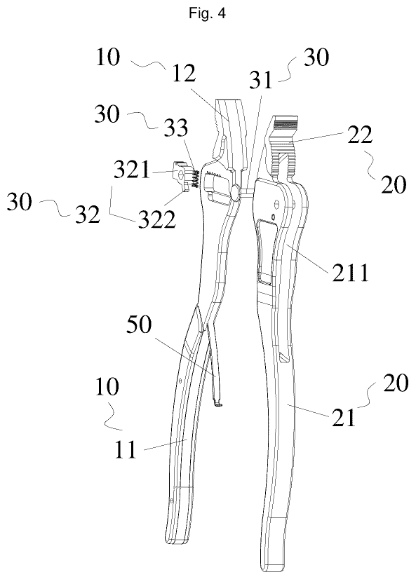

As shown in FIG. 1, FIG. 2, and FIG. 4, in Embodiment 1, the clamping tool further includes an abutting piece 50. The abutting piece 50 is fixed on one of the first handle body 11 and the second handle body 21 and is in abutting fit with the other of the first handle body 11 and the second handle body 21. Through the arrangement of the abutting piece 50, a distance between the first handle body 11 and the second handle body 21 can be increased, thereby increasing the opening distance between the first plier head 12 and the second plier head 22.

As shown in FIG. 1, FIG. 2, and FIG. 4, in Embodiment 1, the abutting piece 50 is arranged on the second handle body 21 and is in abutting fit with the first handle body 11, and an end of the abutting piece 50 is fixed with the second handle body 21. Through the above arrangement, the position of the abutting piece 50 is stable.

In the embodiment not shown in the figures, the abutting piece and the first handle body are integrally formed.

As shown in FIG. 1, FIG. 2, and FIG. 4, in Embodiment 1, the abutting piece 50 includes an elastic sheet. The elastic sheet is simple in structure and convenient for arrangement. Of course, the abutting piece 50 can also be an elastic piece. When the abutting piece 50 is the elastic piece, the elastic piece is connected between the first handle body 11 and the second handle body 21, and the first handle body 11 and the second handle body 21 are stretched open under the action of the elastic piece.

In another embodiment, the abutting piece 50 includes an elastic arm. The elastic arm has a locked position. When the elastic arm is in the locked position, the elastic arm is located inside the second handle body 21. When the elastic arm is in an unlocked position, the elastic arm is in supporting fit with the first handle body 11 and drives the first handle body 11 to move in a direction away from the second handle body 21. The arrangement of the elastic arm is relatively easy, and the elastic arm can move toward the first handle body 11. Specifically, the movement of the elastic arm is rotation, and the elastic arm rotates to push the first handle body 11. In this way, the first handle body 11 and the second handle body 21 can move away from each other.

As shown in FIG. 1 to FIG. 9, in Embodiment 1, the locking piece 32 includes a first locking block 321 and a protrusion 322 connected with the first locking block 321. The first convex tooth 41 is arranged on the first locking block 321, the first locking block 321 is movably arranged in the first sliding groove 111, the first handle body 11 is further provided with a second sliding groove 112, the protrusion 322 is movably arranged in the second sliding groove 112, an inner side wall of the accommodating groove 211 is convexly provided with a stop column 212 located in the second sliding groove 112, and the stop column 212 cooperates with the protrusion 322. When the second handle body 21 rotates, the stop column 212 is in abutting fit with the protrusion 322, so that the first convex tooth 41 and the first rack 42 are unlocked.

As shown in FIG. 1 to FIG. 9, in Embodiment 1, the first sliding groove 111 is adjacent to and communicates with the second sliding groove 112. Through the above arrangement, the overall structure is simpler and convenient for arrangement. The protrusion 322 is movably arranged in the second sliding groove 112, and the stop column 212 cooperates with the protrusion 322. Specifically, the protrusion 322 is located on a side of the first locking block 321.

In the embodiment not shown in the figures, the protrusion is located at an end of the first locking block, so that the first sliding groove and the second sliding groove do not need to be arranged adjacent to each other.

As shown in FIG. 1 to FIG. 9, in Embodiment 1, a side, facing the second sliding groove 112, of the first locking block 321 is provided with a first mounting hole 3211, and the pivot connection locking mechanism 30 further includes a first elastic piece 33. The first elastic piece 33 is inserted into the first mounting hole 3211 and is in abutting fit with the inner wall of the first sliding groove 111. The first elastic piece 33 is arranged in the first mounting hole 3211 and is in abutting fit with the bottom wall of the first sliding groove 111. When the stop column 212 is in stop fit with the protrusion 322, the first elastic piece 33 is compressed. When the second handle body 21 is no longer driven, no stop is provided between the stop column 212 and the protrusion 322, and the first locking block 321 is supported under the action of the first elastic piece 33, so that the first convex tooth 41 and the first rack 42 are engaged with each other, and the position of the locking piece 32 is stabilized.

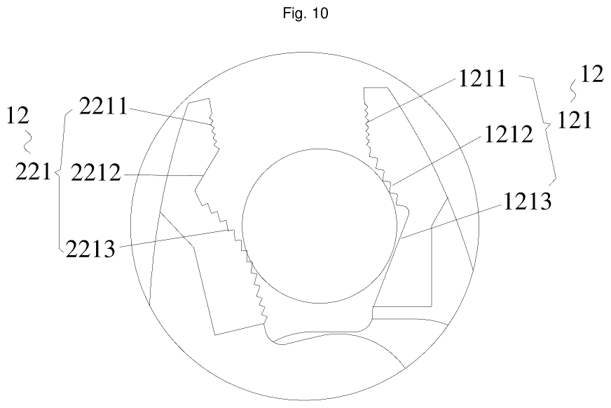

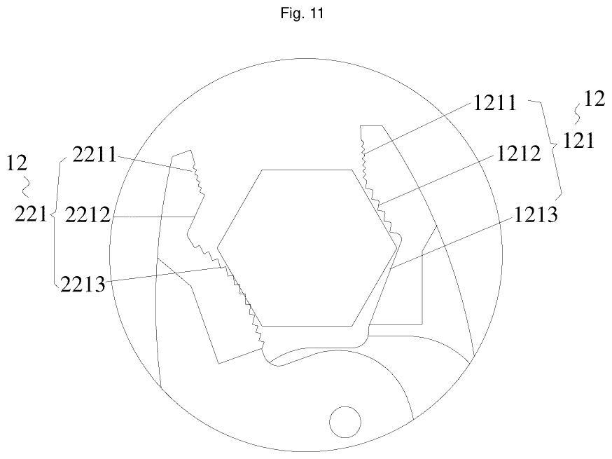

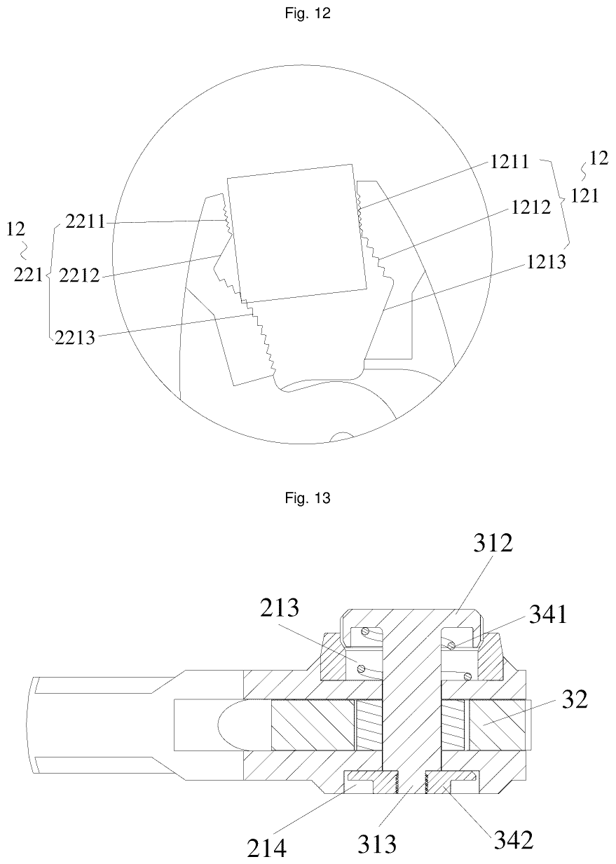

As shown in FIG. 10 to FIG. 12, in Embodiment 1, a side, facing the second plier head 22, of the first plier head 12 is provided with a first clamping surface 121, and a side, facing the first plier head 12, of the second plier head 22 is provided with a second clamping surface 221. The first clamping surface 121 includes a first surface part 1211, a second surface part 1212, and a third surface part 1213, a first obtuse angle being provided between the first surface part 1211 and the second surface part 1212, and a second obtuse angle being provided between the second surface part 1212 and the third surface part 1213. The second clamping surface 221 includes a fourth surface part 2211, a fifth surface part 2212, and a sixth surface part 2213, a third obtuse angle being provided between the fourth surface part 2211 and the fifth surface part 2212, and a fourth obtuse angle being provided between the fifth surface part 2212 and the sixth surface part 2213. The first obtuse angle is greater than the second obtuse angle, and the third obtuse angle is greater than the fourth obtuse angle. Through the above arrangement, the first plier head 12 and the second plier head 22 cooperate with each other to achieve the clamping of objects of different shapes.

As shown in FIG. 10 to FIG. 12, in Embodiment 1, the first surface part 1211 is provided with a first tooth groove, the second surface part 1212 is provided with a second tooth groove, the third surface part 1213 is a smooth surface, the fourth surface part 2211 is provided with a third tooth groove, the fifth surface part 2212 is a smooth surface, and the sixth surface part 2213 is provided with a fourth tooth groove. A tooth width of the first tooth groove is smaller than a tooth width of the second tooth groove, a tooth width of the third tooth groove is smaller than a tooth width of the fourth tooth groove, the tooth width of the first tooth groove is equal to the tooth width of the third tooth groove, and the tooth width of the second tooth groove is equal to the tooth width of the fourth tooth groove. Through the above arrangement, disengagement during clamping can be avoided, thereby the stability of the clamping is better.

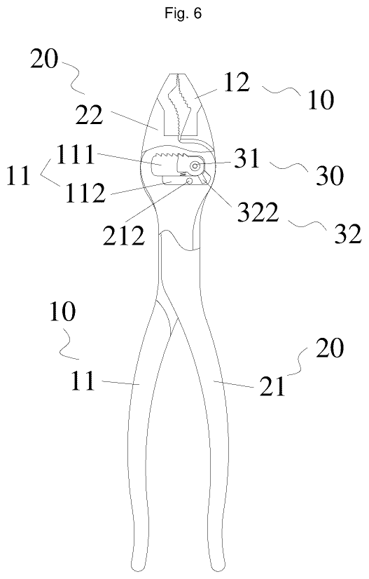

Specifically, as shown in FIG. 6 to FIG. 9, a use process of the technical solution of Embodiment 1 is as follows.

The first plier body 10 is kept stationary, the second handle body 21 is unfolded and rotates around the articulated shaft 31, and the stop column 212 pushes the protrusion 322 to rotate the locking piece 32. After rotating a certain angle, the first convex tooth 41 is separated from the first rack 42. At this time, the second plier body 20 can move in the direction of the first sliding groove 111, and when moving to a suitable position, the second handle body 21 is retracted, and the stop column 212 is separated from the protrusion 322, that is, the stop fit is no longer performed. The locking piece 32 is reset under the action of the first elastic piece 33, so that the first convex tooth 41 is engaged with the first rack 42, thereby achieving the opening process of the clamping tool.

Embodiment 2 differs from Embodiment 1 in that the unlocking manner in Embodiment 1 is the rotation of the locking piece 32, and the rotation of the locking piece 32 is achieved by the stop fit between the stop column 212 and the protrusion 322, and the first elastic piece 33. In the embodiment, although the locking piece 32 is also unlocked by rotation, the rotation of the locking piece 32 is achieved by the cooperation between a spiral groove 311 and a driving block 324.

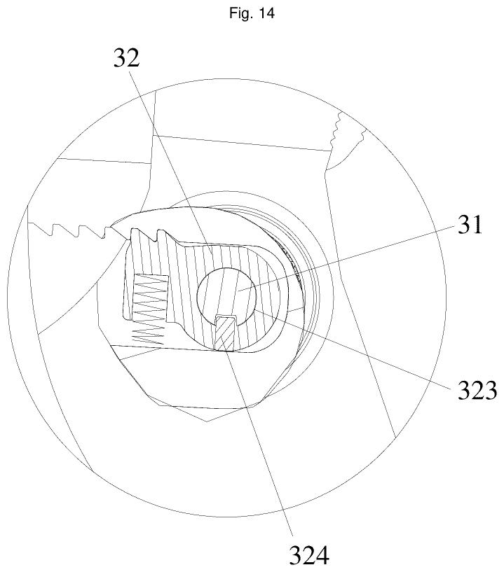

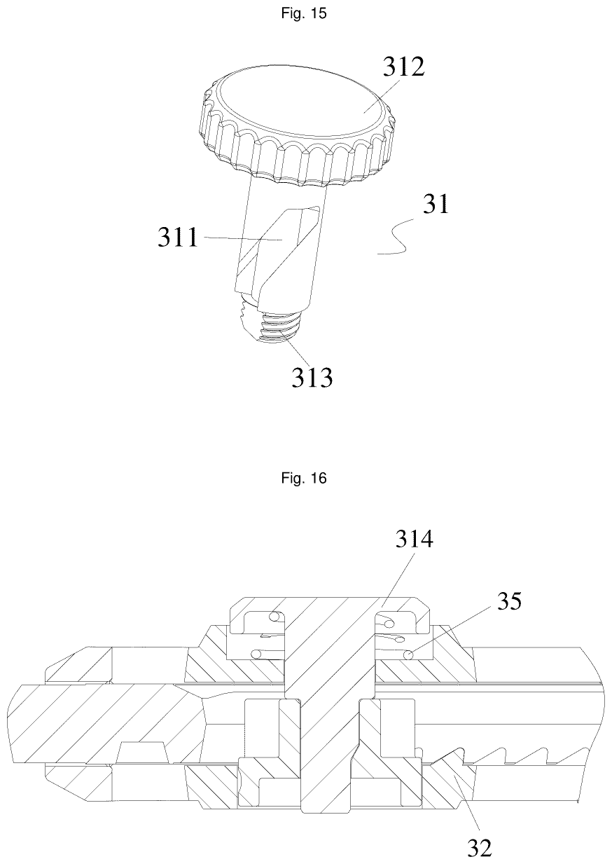

As shown in FIG. 13 to 15, in Embodiment 2, the articulated shaft 31 can move in an axial direction of the articulated shaft 31, a side wall of the articulated shaft 31 is provided with the spiral groove 311, the locking piece 32 is provided with a second mounting hole 323, the locking piece 32 is provided with the driving block 324 extending into the second mounting hole 323, and the driving block 324 is inserted into the spiral groove 311. The driving block 324 is in the spiral groove 311, and when the articulated shaft 31 is pressed, the driving block 324 can move along the spiral groove 311, that is, the driving block 324 swings within a certain angle range, and since the driving block 324 is arranged on the locking piece 32, the locking piece 32 can also swing, and at this time, the first convex tooth 41 can be separated from the first rack 42. The arrangement manner is simple and can achieve the change of the position of the articulated shaft 31.

As shown in FIG. 13 to 15, in Embodiment 2, a first end of the articulated shaft 31 is located on a first side of the second handle body 21 and is provided with a first pressing part 312, a second end of the articulated shaft 31 is located on a second side of the second handle body 21 and is provided with a threaded part 313, and the pivot connection locking mechanism 30 further includes a second elastic piece 341 and a fastener 342, the second elastic piece 341 being arranged between the first pressing part 312 and the first side of the second handle body 21, and the fastener 342 being fixedly connected with the threaded part 313. Through the arrangement of the fastener 342 and the first pressing part 312, the stability of the position of the articulated shaft 31 can be ensured, and when the articulated shaft 31 moves, the second elastic piece 341 can drive the articulated shaft 31 to reset, so that the first convex tooth 41 is engaged with the first rack 42.

As shown in FIG. 13 to FIG. 15, in Embodiment 2, the first side of the second handle body 21 is provided with a first recess 213, the second side of the second handle body 21 is provided with a second recess 214, the second elastic piece 341 is arranged in the first recess 213, and the fastener 342 is arranged in the second recess 214. Through the arrangement of the first recess 213 and the second recess 214, the overall structure is more regular.

Embodiment 3 differs from Embodiment 2 in that the locked position is changed. In Embodiment 2, the locked position is on the inner wall of the first sliding groove 111 close to the first plier head 12, while the locked position of Embodiment 3 is on the side wall of the first sliding groove 111 away from the first plier head 12.

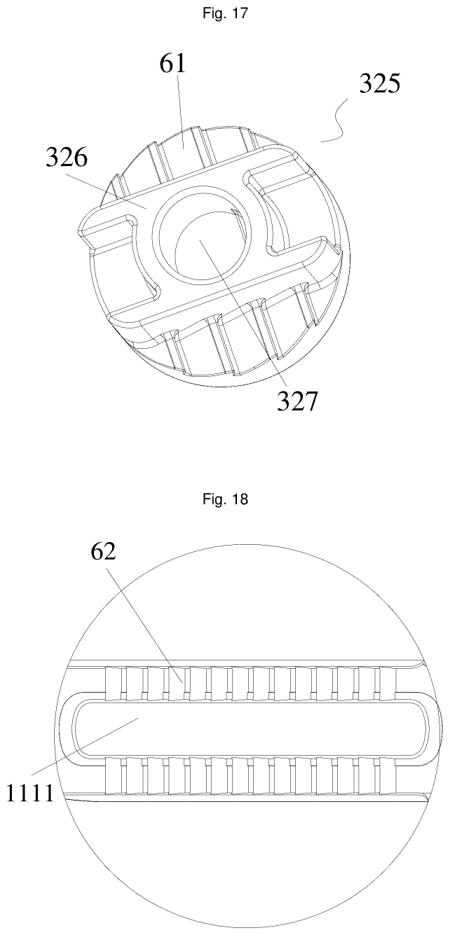

As shown in FIG. 16 to FIG. 18, in Embodiment 3, the locking piece 32 includes a second locking block 325 and a guide block 326. The guide block 326 is arranged on a first side wall of the second locking block 325, at least one side of the guide block 326 is provided with a second convex tooth 61, a side wall of the first sliding groove 111 is provided with a guide groove 1111 and a second rack 62, the guide block 326 is in guide fit with the guide groove 1111, and the second convex tooth 61 and the second rack 62 are snap-fitted. The guide block 326 can move in the guide groove 1111, so that the movement of the second locking block 325 is more stable. When the articulated shaft 31 is pressed, the second convex tooth 61 and the second rack 62 can be disengaged from each other, so that the locking piece 32 can move in the first sliding groove 111.

Specifically, as shown in FIG. 16 to FIG. 18, in Embodiment 3, the guide block 326 is arranged on the center line of the second locking block 325, the surface, facing the first plier head 12, of the second locking block 325 is divided into two parts, which are respectively provided with the second convex tooth 61.

As shown in FIG. 16 to FIG. 18, in Embodiment 3, the locking piece 32 includes a third mounting hole 327. The third mounting hole 327 is arranged at the center of the second locking block 325 and penetrates through the guide block 326, the articulated shaft 31 penetrates through the third mounting hole 327, a first end of the articulated shaft 31 is provided with a second pressing part 314, and the pivot connection locking mechanism 30 further includes a third elastic piece 35. The third elastic piece 35 is arranged between the second pressing part 314 and the second handle body 21. Through the arrangement of the third elastic piece 35, the articulated shaft 31 can be driven to reset, so that the second convex tooth 61 and the second rack 62 are engaged with each other, thereby locking the second locking block 325.

Furthermore, it is to be noted that the use of the words “first”, “second” and the like to define parts is only for the convenience of distinguishing the corresponding parts, unless otherwise stated, the words have no special meaning, and therefore cannot be construed as limiting the scope of protection of the present disclosure.

The above is only the preferred embodiments of the present disclosure, and is not intended to limit the present disclosure, and for those of ordinary skill in the art, various modifications and changes may be made to the present disclosure. Any modifications, equivalent substitutions, improvements, etc. within the spirit and scope of the present disclosure shall be included in the scope of protection of the present disclosure.

1. A clamping tool, comprising:
a first plier body, comprising a first handle body and a first plier head arranged at an end of the first handle body;
a second plier body, comprising a second handle body and a second plier head arranged at an end of the second handle body, the second plier body being hinged with the first plier body; and
a pivot connection locking mechanism which is movably arranged at a position where the first plier body is hinged with the second plier body;
wherein the pivot connection locking mechanism has an unlocked state and a locked state; when in the locked state, the first plier head is pivotally connected with the second plier head; and when in the unlocked state, the first plier head and the second plier head can move toward or away from each other.

2. The clamping tool according to claim 1, wherein the first plier body and the second plier body are arranged crosswise.

3. The clamping tool according to claim 1, wherein, when the pivot connection locking mechanism rotates or moves, the pivot connection locking mechanism switches between the locked state and the unlocked state; and when the pivot connection locking mechanism is in the unlocked state, the pivot connection locking mechanism can move, so that the first plier head and the second plier head move toward or away from each other.

4. The clamping tool according to claim 1, wherein, when the pivot connection locking mechanism is in the unlocked state, the first plier head moves toward the second plier head or the second plier head moves toward the first plier head.

5. The clamping tool according to claim 2, wherein the second handle body comprises an accommodating groove, wherein at least part of a structure of the first handle body can be inserted into the accommodating groove the first handle body is provided with a first sliding groove and the pivot connection locking mechanism is movably arranged in the first sliding groove.

6. The clamping tool according to claim 5, wherein the pivot connection locking mechanism comprises an articulated shaft and a locking piece wherein the articulated shaft penetrates through the second handle body and the locking piece

7. The clamping tool according to claim 6, wherein a snap-fit structure is arranged between the locking piece and an inner wall of the first sliding groove and the snap-fit structure comprises a first convex tooth and a first rack, wherein one of the first convex tooth and the first rack is arranged on the locking piece the other of the first convex tooth and the first rack is arranged in the first sliding groove and the first convex tooth and the first rack are snap-fitted.

8. The clamping tool according to claim 7, wherein the first convex tooth is arranged on the locking piece the first rack is arranged on an inner wall, close to the first plier head, of the first sliding groove, the first convex tooth protrudes toward a side of facing the first plier head, or the first rack is arranged on an inner wall, away from the first plier head of the first sliding groove and the first convex tooth protrudes toward a side away from the first plier head.

9. The clamping tool according to claim 6, further comprising an abutting piece, wherein the abutting piece is fixed on one of the first handle body and the second handle body and is in abutting fit with the other of the first handle body and the second handle body

10. The clamping tool according to claim 9, wherein the abutting piece is arranged on the second handle body and is in abutting fit with the first handle body.

11. The clamping tool according to claim 10, wherein the abutting piece comprises an elastic sheet.

12. The clamping tool according to claim 9, wherein the abutting piece comprises an elastic arm, wherein the elastic arm has a locked position and an unlocked position; when the elastic arm is in the locked position, the elastic arm is located inside the second handle body; and when the elastic arm is in the unlocked position, the elastic arm is in supporting fit with the first handle body and drives the first handle body to move in a direction away from the second handle body.

13. The clamping tool according to claim 7, wherein the locking piece comprises a first locking block and a protrusion connected with the first locking block, wherein the first convex tooth is arranged on the first locking block, the first locking block is movably arranged in the first sliding groove the first handle body is further provided with a second sliding groove the protrusion is movably arranged in the second sliding groove an inner side wall of the accommodating groove is convexly provided with a stop column located in the second sliding groove and the stop column cooperates with the protrusion.

14. The clamping tool according to claim 13, wherein the first sliding groove is adjacent to and communicates with the second sliding groove.

15. The clamping tool according to claim 13, wherein a side, and facing the second sliding groove, of the first locking block is provided with a first mounting hole and the pivot connection locking mechanism further comprises a first elastic piece wherein the first elastic piece is inserted into the first mounting hole and is in abutting fit with the inner wall of the first sliding groove.

16. The clamping tool according to claim 6, wherein the articulated shaft can move in an axial direction of the articulated shaft, a side wall of the articulated shaft is provided with a spiral groove, the locking piece is provided with a second mounting hole, the locking piece is provided with a driving block extending into the second mounting hole, and the driving block is inserted into the spiral groove.

17. The clamping tool according to claim 16, wherein a first end of the articulated shaft is located on a first side of the second handle body and is provided with a first pressing part, a second end of the articulated shaft is located on a second side of the second handle body and is provided with a threaded part and the pivot connection locking mechanism further comprises a second elastic piece and a fastener the second elastic piece being arranged between the first pressing part and the first side of the second handle body, and the fastener being fixedly connected with the threaded part.

18. The clamping tool according to claim 17, wherein the first side of the second handle body is provided with a first recess the second side of the second handle body is provided with a second recess, the second elastic piece is arranged in the first recess, and the fastener is arranged in the second recess.

19. The clamping tool according to claim 6, wherein the locking piece comprises a second locking block and a guide block, wherein the guide block is arranged on a first side wall of the second locking block, at least one side of the guide block is provided with a second convex tooth a side wall of the first sliding groove is provided with a guide groove and a second rack, the guide block is in guide fit with the guide groove and the second convex tooth and the second rack are snap-fitted.

20. The clamping tool according to claim 19, wherein the locking piece comprises a third mounting hole, wherein the third mounting hole is arranged at a center of the second locking block and penetrates through the guide block, the articulated shaft penetrates through the third mounting hole a first end of the articulated shaft is provided with a second pressing part, and the pivot connection locking mechanism further comprises a third elastic piece the third elastic piece being arranged between the second pressing part and the second handle body.

21. The clamping tool according to claim 1, wherein a side, facing the second plier head, of the first plier head is provided with a first clamping surface and a side, facing the first plier head of the second plier head is provided with a second clamping surface; the first clamping surface comprises a first surface part a second surface part, and a third surface part, a first obtuse angle being provided between the first surface part and the second surface part and a second obtuse angle being provided between the second surface part and the third surface part the second clamping surface comprises a fourth surface part a fifth surface part, and a sixth surface part, a third obtuse angle being provided between the fourth surface part and the fifth surface part and a fourth obtuse angle being provided between the fifth surface part and the sixth surface part; and the first obtuse angle is greater than the second obtuse angle, and the third obtuse angle is greater than the fourth obtuse angle.

22. The clamping tool according to claim 21, wherein the first surface part is provided with a first tooth groove, the second surface part is provided with a second tooth groove, the third surface part is a smooth surface, the fourth surface part is provided with a third tooth groove, the fifth surface part is a smooth surface, and the sixth surface part is provided with a fourth tooth groove; and a tooth width of the first tooth groove is smaller than a tooth width of the second tooth groove, a tooth width of the third tooth groove is smaller than a tooth width of the fourth tooth groove, the tooth width of the first tooth groove is equal to the tooth width of the third tooth groove, and the tooth width of the second tooth groove is equal to the tooth width of the fourth tooth groove.
